(19) United States
(12) Patent Application Publication
(10) Pub. No.: US 2010/0182195 A1
(43) Pub. Date: Jul. 22, 2010

(54) Resolving Transmit Time Uncertainty in Carrier Phase Relative Positioning

(75) Inventor: Lionel J. Garin, Palo Alto, CA (US)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 12/355,610

(22) Filed: Jan. 16, 2009

(51) Int. Cl. G01S 5/14

(52) U.S. Cl. 342/357.03; 342/357.04

(57) ABSTRACT

Methods and apparatus are provided for use in electronic devices to perform carrier phase relative positioning processing.

### BACKGROUND

1. Field

The subject matter disclosed herein relates to electronic devices, and more particularly to methods and apparatuses for use in electronic devices adapted to perform carrier phase relative positioning processing.

2. Information

Wireless communication systems and devices are fast becoming one of the most prevalent technologies in the digital information arena. Satellite and cellular telephone services and other like wireless communication networks may already span the entire globe. Additionally, new wireless systems (e.g., networks) of various types and sizes are added each day to provide connectivity between a plethora of devices, both fixed and portable. Many of these wireless systems are coupled together through other communication systems and resources to promote even more communication and sharing of information. Indeed, it is not uncommon for some devices to be adapted to communicate with more than one wireless communication system and this trend appears to be growing.

Another popular and increasingly important wireless technology includes navigation systems and devices and in particular satellite positioning systems (SPS) such as, for example, the global positioning system (GPS) and other like Global Navigation Satellite Systems (GNSS). An SPS receiver path, for example, may receive wireless SPS signals that are transmitted by a plurality of orbiting satellites of a GNSS. Received SPS signals may be processed, for example, to determine a global time, an approximate geographical location, altitude, and/or speed associated with a device having SPS receiver path.

### SUMMARY

Methods and apparatuses for use in electronic devices adapted to perform carrier phase relative positioning processing.

By way of example but not limitation, a method may be provided for use with a device having a Satellite Positioning System (SPS) receiver. The method include determining a current chip number associated with a spread-spectrum sequence in at least one received SPS signal transmitted by at least one space vehicle (SV), determining a fraction of a chip associated with at least one carrier signal phase measurement sample, and determining at least one SV transmit time based, at least in part on a local receiver time, the current chip number, and the fraction of the chip.

In certain implementations, a method may also include determining a carrier phase integer ambiguity associated with at least the SV transmit time, and determining at least one cumulated carder phase measurement based, at least in part, on the SV transmit time and the carrier phase integer ambiguity.

In certain implementations, a method may also include determining a Double Difference (DD) Carrier Phase observable based, at least in part, on the cumulated carrier phase measurement. Here, for example, a DD Carrier Phase observable may be associated, at least in part, with at least one other receiver of at least one other device.

In certain example implementations, a local receiver may be associated with a slave receiver and the other device may include a master device, wherein the slave and master devices, for example, are operatively coupled together through at least a portion of a wireless network.

In certain implementations, a method may also include establishing a local receiver time based, at least in part, on synchronization information associated with a master device, wherein the master device and the SV, for example, are at least substantially synchronized to an SPS system time.

In certain implementations, a method may also include determining a transmit time ambiguity associated with a slave device based, at least in part, on at least one DD Carrier Phase observable, and resolving a single unknown parameter vector based, at least in part, on a transmit time ambiguity associated with the slave device, and at least one DD integer ambiguity associated with at least the SV.

In certain implementations, a method may also include determining a DD carrier phase linearization point based, at least in part, on the DD carrier phase observable, and determining a relative position between at least slave and master devices based, at least in part, on the DD carrier phase linearization point.

By way of further example but not limitation, an apparatus may be provided which includes a receiver operatively enabled to acquire at least one SPS signal associated with a spread-spectrum sequence as transmitted using a carrier signal by at least one SV, and at least one processing unit operatively coupled to the receiver. Here, for example, the processing unit may be operatively enabled to determine a current chip number associated with the spread-spectrum sequence, determine a fraction of a chip associated with at least one carrier signal phase measurement sample, and determine at least one SV transmit time based, at least in part on a local receiver time, the current chip number, and the fraction of the chip.

By way of still further example but not limitation, an article of manufacturer may be provided which includes a computer readable medium having stored thereon computer implementable instructions that if implemented by one or more processing units. The computer implementable instructions may operatively enable the one or more processing unit to determine a current chip number associated with a spread-spectrum sequence in at least one received SPS signal transmitted by at least one SV, determine a fraction of a chip associated with at least one carrier signal phase measurement sample, and determine at least one SV transmit time based, at least in part on a local receiver time, the current chip number, and the fraction of the chip.

### BRIEF DESCRIPTION OF DRAWINGS

Non-limiting and non-exhaustive aspects are described with reference to the following figures, wherein like reference numerals refer to like parts throughout the various figures unless otherwise specified.

FIG. 1 is schematic block diagram illustrating an exemplary wireless signaling environment that includes at least one device adapted to perform carder phase relative positioning processing in accordance with an example implementation.

FIG. 2 is a graph diagram illustrating plotted exemplary simulated data showing the effect of synchronization time uncertainty between units on Integer Ambiguity Resolution Success Rate, as may be associated with the exemplary wireless signaling environment of FIG. 1, for example.

FIG. 3 is a graph diagram illustrating plotted exemplary simulated data showing the effect of synchronization time uncertainty on Time-To-Fix-Ambiguities, as may be associated with the exemplary wireless signaling environment of FIG. 1, for example.

FIG. 4 is a graph diagram illustrating plotted exemplary simulated data showing the effect of synchronization time uncertainty on the number of potential integer solutions to explore, as may be associated with the exemplary wireless signaling environment of FIG. 1, for example.

FIG. 5 is a schematic block diagram illustrating certain features of an exemplary device having at least one wireless interface and processing resources adapted to perform carrier phase relative positioning processing in accordance with an example implementation and which may be provided within the environment of FIG. 1, for example.

FIG. 6 is a flow diagram illustrating an exemplary method that may be implemented within carrier phase relative positioning processing within the environment of FIG. 1 and/or device of FIG. 5, for example.

### DETAILED DESCRIPTION

In the following detailed description, numerous specific details are set forth to provide a thorough understanding of claimed subject matter. However, it will be understood by those skilled in the art that claimed subject matter may be practiced without these specific details. In other instances, well-known methods, procedures, components and/or circuits have not been described in detail.

Techniques are presented that may be implemented in various methods and apparatuses for use with electronic devices to perform carrier phase relative positioning processing.

Reference throughout this specification to “one example”, “an example”, “certain examples”, or “exemplary implementation” means that a particular feature, structure, or characteristic described in connection with the feature and/or example may be included in at least one feature and/or example of claimed subject matter. Thus, the appearances of the phrase “in one example”, “an example”, “in certain examples” or “in certain implementations” or other like phrases in various places throughout this specification are not necessarily all referring to the same feature, example, and/or limitation. Furthermore, the particular features, structures, or characteristics may be combined in one or more examples and/or features.

Techniques described herein may be implemented by various means depending upon applications according to particular features and/or examples. For example, such techniques may be implemented in hardware, firmware, software, and/or combinations thereof. In a hardware implementation, for example, a processing unit may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other devices units designed to perform the functions described herein, and/or combinations thereof.

Techniques described herein may be implemented, for example, as methods and/or apparatuses associated with one or more electronic devices. Examples of such devices herein include navigation and/or communication related devices. However, claimed subject matter is not intended to be limited to just these examples.

In accordance with one aspect of the present description, certain exemplary, techniques are presented that may, for example, be implemented in one or more devices to help resolve transmit time uncertainty in accurate three-dimensional carrier phase relative positioning based, at least in part, on SPS signals. Such techniques may be implemented, for example, as a method that may be considered as an assisted-GPS (and/or other like assisted-GNSS) counterpart for accurate relative carrier phase positioning.

In certain implementations, such a method may be implemented to establish and/or otherwise estimate a three-dimensional distance between two receiving devices (e.g., a master device and a slave device, two slave devices, etc.) to within a centimeter or better accuracy within a short amount of time (e.g., perhaps 5-10 seconds or faster) after SPS signal acquisition should the receiving devices be within a vicinity of each other of up to approximately 5.0 km or so. Both receiving devices may be wirelessly connected either to each other, and/or to one or more other devices, such as, e.g., a common position determination device or the like.

In certain exemplary techniques presented herein, a system may be provided that includes a reference receiving device (e.g., a master device) and at least one roving device (e.g., a slave device). Master device may be substantially accurately (e.g., sub-microsecond) synchronized to/on SPS system time (e.g., GPS/GNSS time) and slave device may be loosely synchronized to such SPS system time, e.g., by external means, such as a wireless network connection and/or the like. In certain exemplary implementations it is reasonably expected that such a system implementing exemplary techniques, at least in part, as provided herein may be able to operatively tolerate at least up to approximately 100 ms of synchronization error between master and slave devices.

As described in greater detail in subsequent sections, both master and slave devices in such an exemplary system may collect cumulated carrier phase information associated with SPS signals. However, in accordance with an aspect of the present description, a master device may collect such carrier phase information at very accurate SPS system time, while a slave device may collect such carrier phase information with a time tag uncertainty (e.g., up to 100 ms, and/or as otherwise may be consistent with a synchronization error).

Those skilled in the art will come to recognize throughout this detailed description and accompanying drawings that certain methods, apparatuses, and/or systems implementing such techniques may provide several benefits and/or other advantages over other similarly accurate positioning techniques. Such other techniques include, for example, an accurate three-dimensional relative positioning of GPS/GNSS receivers as may be accomplished between at least two full-fledged “surveyor grade” or other like GPS/GNSS receivers each having significant reception and processing capabilities and which may be operated to provide enough time to process fully SPS signals and/or otherwise determine accurate relative positioning.

As is known, very accurate relative positioning may be accomplished, at least in part, by using SPS signal carrier phase measurements. Certain carrier phase measurements may be very precise having, for example, a thermal noise in the vicinity of 2-3 millimeters. However, as is known, such carrier phase measurements may suffer from an unknown ambiguity of an integer number of times the wavelength of the carrier frequency (e.g., about 19 centimeters for GPS L1).

It is known, for example, that carrier phase measurements may be combined into Double Difference Carrier Phase observables (e.g., differencing measurements between receiving device(s) and between SV(s) for elimination of common mode errors and resolution of Double Difference (DD) carrier phase integer ambiguities techniques (e.g., via a DD algorithm and/or other like processes). Thus, in certain known systems, successful and correct determination of DD integer ambiguities may necessitate quasi simultaneous measurement of carrier phases at both ends of a baseline (e.g., where the antennas of the receivers are located) within 5.0 microseconds, otherwise the ambiguity resolution success rate may drastically decrease.

A traditional approach may include determining each receiver clock offset and drift using code phase and code range rate measurements (possibly smoothed out using Carrier Phase and Carrier Phase Rate measurements), and applying a standard absolute positioning algorithm that establishes a receiver's clock offset and clock rate offset versus SPS system time. The quality of this error determination may be of the order of 1.0 microsecond or less at both ends of the baseline. The carrier phase measurements may then be collected at each end of the baseline, for example, at a predefined SPS system time (e.g., usually at the top of each GPS second). The DD algorithm may be applied to the carrier phase measurements.

In accordance with certain aspects of the present description, techniques presented herein may be implemented such that there may be a large synchronization time error associated with a slave device and there may be no need to try to resolve for a slave device's clock offset first. Instead, techniques provided herein may be implemented, at least in part, to model transmit times as accurate values, e.g., with integer millisecond ambiguities, resolve a transmit time at a sub microsecond range (e.g., to compare to a 10-100 ms range for a classical Unknown Transmit Time Algorithm Resolution applied on code phase measurements, that resolve unknown satellite transmit time using an extra measurement), and/or to enable a correct double difference ambiguity resolution.

In accordance with certain example implementations, such techniques may be implemented for use in Wireless Sensor Networks (WSNS) and/or the like, wherein certain known techniques may be impractical. By way of example but not limitation, a WSN may include devices (e.g., slave devices) having minimal processing, memory, and/or energy resource capabilities. Such WSN devices and/or the like may operatively act as self-organized nodes and/or be interconnected by wireless ad-hoc networks, for example. As such, for at least these reasons and/or others, implementation of a full fledged SPS function in each device/node may be impractical. Instead, such devices may be provided with partial and/ otherwise limited implementations of SPS functionality and accurate clock synchronization may not therefore be possible at each device/node (or mote) as would be expected in a known system.

Given diminished/reduced SPS capabilities of such slave devices, one potential solution is to allow a master device, which may be included with adequately “full” SPS capabilities, to synchronize to SPS system time (e.g., to within less than 1.0 microsecond). Such a master device may, for example, be connected a largely available power source and thus continuously track GPS signals and/or may have further connectivity with other devices/networks services. A WSN slave device may, for example, be operatively coupled to such a master device and synchronized to this master node through an ad-hoc wireless communication link and/or the like.

Those skilled in the art will recognize that certain wireless protocols may be implemented in certain systems to address such synchronization problems. By way of example, methods such as RBS (Reference Broadcast Synchronization) or TPSN (Timing-Sync Protocol for Sensor Networks) may be implemented, at least in part, to provide certain levels of synchronization between and/or among devices in a WSN. Unfortunately, such methods appear to be limited as the potential synchronization time uncertainty may be on the order of 10.0-20.0 microseconds. This may be inadequate for certain implementations, as presented in subsequent sections herein, for example, wherein 3.0-5.0 microseconds may be more appropriate for suitable integer ambiguity resolution.

With this in mind, for example, certain example techniques provided herein may include resolving an SV transmit time uncertainty as an extra integer ambiguity parameter per node, in addition to resolving carrier phase double differences ambiguities. Consequently, in certain implementations, both time and distance ambiguities may be jointly resolved in the same process.

Moreover, as presented in certain examples herein, an unknown transmit time (and mathematically related unknown receive time) may be resolved along with the Double Difference Carrier Phase ambiguities, where a search domain is now two-dimensional, e.g., position and time. Such techniques may provide several benefits/advantages over a code-only transmit time determination. For example the solution strength may be better.

While in certain implementations the system in which techniques presented herein may include a WSN, it should be clear that such techniques may be implemented in other systems. By way of example but not limitation, techniques presented herein may be implemented to provide accurate relative positioning between various wireless devices, cellular telephones, mobile handsets, and/or other the like using carrier phase positioning. Such devices may be provided with partial and/or otherwise limited implementations of SPS functionality and accurate clock synchronization may not therefore be possible at each device. Thus, in certain example implementations, in certain mobile devices (e.g., cell phones) there may be no need for a full carrier Phase GPS implementation. A time transfer accuracy that one may achieve using a mechanism developed for A-GPS (e.g., code phase only) may not be accurate enough to guarantee a time synchronization within 5 μs. One reason may be that the distance to a synchronizing device (e.g., cell tower) may be as large as 20 km, introducing a synchronization time uncertainty larger than 6 μs.

In still other examples, techniques presented herein may be adapted for use in Dedicated Short Range Communications (DSRC) systems to provide for an accurate relative positioning between vehicles or between a vehicle and roadside infrastructure (Intelligent transportation systems) for automatic anti-collision systems and/or the like.

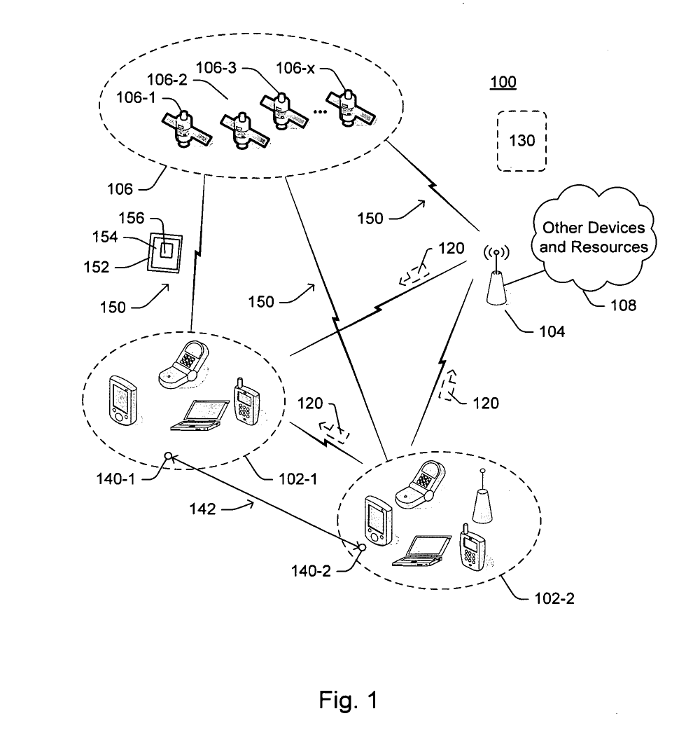

Reference is now made to FIG. 1, which is block diagram illustrating an exemplary wireless signaling environment 100 that includes at least two devices, each of which may be adapted to collaborate in performing carrier phase relative positioning processing in accordance with an example implementation.

Wireless environment 100 may include various computing and communication resources. This example implementation may be adapted to provide and/or otherwise support at least some form of navigation and/or positioning services in accordance with certain exemplary implementations of the present description. This example implementation may also be adapted to provide at least some form of communication services in accordance with certain exemplary implementations of the present description.

As for navigation services, for example, as shown in FIG. 1 an SPS 106 may include a plurality of SVs 106-1, 106-2, 106-3, . . . , 106-x that may transmit SPS signals 150 to at least one device 102-1, 102-2, 104. Here, for example, devices 102-1 and/or device 102-2 may represent a “slave device” and device 104 may represent a “master” device, base station, etc. In certain implementations, device 102-2 may also represent a master or other like device. However arranged, to perform carrier phase relative positioning processing in accordance with an example implementation, the slave and master devices may be enabled to acquire the same SPS signals. Here, by way of example, one SPS signal 150 is illustrated as having a carrier signal 152, a PN/PRN or other like code or spread-spectrum sequence 154, and possibly other information 156 (e.g., ephemeris data, etc.).

As illustrated in FIG. 1, Device 102-1 may have a three-dimensional location 140-1 and device 102-2 may have a three-dimensional location 140-2, and as such are separated a relative distance 142.

By way of example but not limitations as illustrated using icons in FIG. 1, devices 102-1 and/or 102-2 may include a mobile device such as a cellular phone, a smart phone, a personal digital assistant, a portable computing device, a navigation unit, a ranging and/or positioning unit, and/or the like or any combination thereof. In other exemplary implementations, devices 102-1 and/or 102-2 may take the form of a machine that is mobile or stationary. In certain implementations device 102-2 may include a “master device” as represented by the network node icon. In certain exemplary implementations, devices 102-1 and 102-2 may take the same form or may take on different forms. In still other exemplary implementations, devices 102-1 and 102-2 (or 104) may take the form of one or more integrated circuits, circuit boards, and/or the like that may be operatively adapted for use with and/or within another device(s).

In certain implementations wireless environment 100 may further include and/or alternatively include various computing and communication resources adapted to provide communication and/or other information processing services with respect to devices 102-1, 102-2, and/or 104. Wireless environment 100 may be representative of any system(s) or a portion thereof that may include at least one device adapted to transmit and/or receive wireless signals to/from at least one wireless communication system of which device 104 may be part of and/or otherwise operatively associated therewith. For example, in certain implementations, device 104 may include a base station and/or other like device/functionality as part of the wireless communication system. Thus, as illustrated in FIG. 1, device 104 may be adapted to communicate with and/or otherwise operatively access other devices and/or resources as represented simply by cloud 108. For example, cloud 108 may include one or more communication devices, systems, networks, or services, and/or one or more computing devices, systems, networks, services, and/or the like or any combination thereof.

The various devices in FIG. 1 may, for example, be adapted for use with various wireless communication networks such as a wireless wide area network (WWAN), a wireless local area network (WLAN), a wireless personal area network (WPAN), and so on. The term “network” and “system” may be used interchangeably herein. A WWAN may be a Code Division Multiple Access (CDMA) network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, and so on. A CDMA network may implement one or more radio access technologies (RATs) such as cdma2000, Wideband-CDMA (W-CDMA), to name just a few radio technologies. Here, cdma2000 may include technologies implemented according to IS-95, IS-2000, and IS-856 standards. A TDMA network may implement Global System for Mobile Communications (GSM), Digital Advanced Mobile Phone System (D-AMPS), or some other RAT. GSM and W-CDMA are described in documents from a consortium named “3rd Generation Partnership Project” (3GPP). Cdma2000 is described in documents from a consortium named “3rd Generation Partnership Project 2” (3GPP2). 3GPP and 3GPP2 documents are publicly available. A WLAN may include an IEEE 802.11x network, and a WPAN may include a Bluetooth network, an IEEE 802.15x, for example.

A slave and/or master device in FIG. 1 may be adapted to receive transmissions from SVs 106-1, 106-2, 106-3, . . . , 106-x and to perform various navigation and/or timing processes as might be expected of devices adapted to acquire and process SPS signals from the SVs. Here, such devices may be adapted for use with one or more different SPS'. Furthermore, such devices may be used with positioning determination systems that utilize pseudolites or a combination of SVs and pseudolites. Pseudolites may include ground-based transmitters that broadcast a PN code or other ranging code (e.g., similar to a GPS or CDMA cellular signal) modulated on an L-band (or other frequency) carrier signal, which may be synchronized in some manner with an SPS system time. Such a transmitter may be assigned a unique PN code so as to permit identification by a remote receiver. In certain GNSS, such as GLONASS, there may be a unique PN sequence, common to all satellites, but each satellite transmits on a unique frequency. Pseudolites may be useful in situations where SPS signals from an orbiting SV might be unavailable, such as in tunnels, mines, buildings, urban canyons or other enclosed areas. Another implementation of pseudolites is known as radio-beacons. The term “SV”, as used herein, is intended to include pseudolites, equivalents of pseudolites, and possibly others. The terms “SPS signals” and/or “SV signals”, as used herein, is intended to include SPS-like signals from pseudolites or equivalents of pseudolites.

As illustrated in FIG. 1, associated with an SPS, there may be an SPS system time 130, for example. In certain implementations, one or more SPS resources may be accurately synchronized to SPS system time 130.

As illustrated in FIG. 1, messages 120 and/or other like information associated with the operation of the various devices in wireless environment 100 may be transmitted or otherwise exchanged. For example, message 120 may include synchronization information and/or other like data. As illustrated, device 102-2 may provide message 120 directly to device 102-1, and/or indirectly via other resources such as device 104.

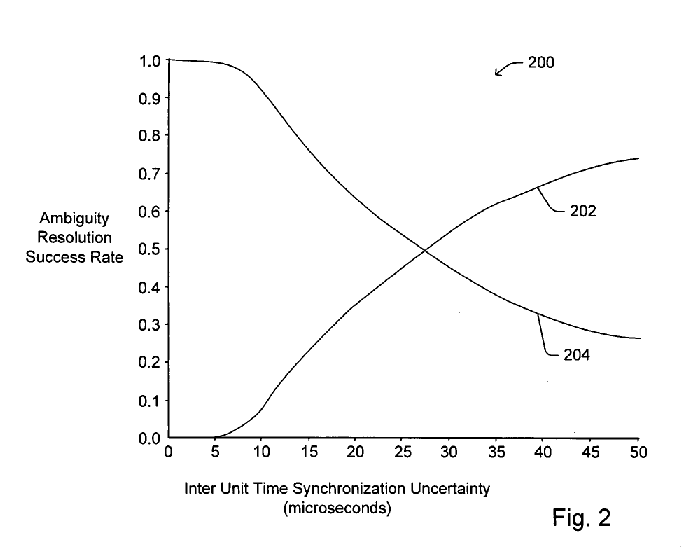

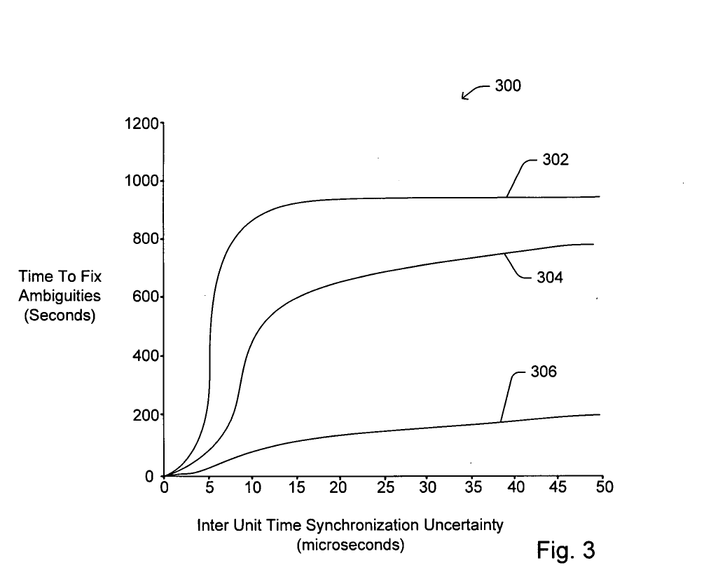

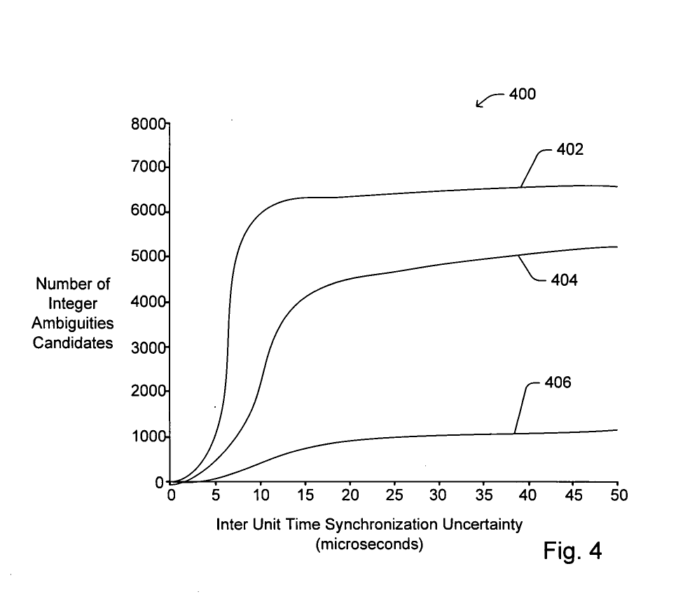

Attention is drawn next to FIGS. 2-4, which are graphs illustrating through plotted exemplary simulated data, synchronization time uncertainty effect on Integer Ambiguity Resolution Success Rate (see graph 200 of FIG. 2), on Time-To-Fix-Ambiguities (see graph 300 of FIG. 3), and on the number of potential integer solutions to explore (e.g., CPU load) (see graph 400 of FIG. 4).

More specifically, graph 200 shows a simulated ambiguity resolution versus an inter-node time synchronization standard deviation error. Graph 200 includes probability on the y-axis and synchronization standard deviation error (microseconds) on the x-axis. Curve 202 approximates a simulation failure rate and curve 204 approximates a simulation success rate.

More specifically, graph 300 shows a simulated time to fix integer ambiguity versus an inter-node time synchronization standard deviation error. Graph 300 includes time (seconds) on the y-axis and synchronization standard deviation error (microseconds) on the x-axis. Curve 302 approximates a simulation maximum time to fix integer ambiguity measure, curve 304 approximates a simulated 95% time to fix integer ambiguity measure, and curve 306 approximates a simulated average time to fix integer ambiguity measure.

More specifically, graph 400 shows a simulated search workload versus an inter-node time synchronization standard deviation error in number of searches. Graph 400 includes workload (in number of branches) on the y-axis and synchronization standard deviation (microseconds) on the x-axis. Curve 402 approximates a simulation maximum number of branches, curve 304 approximates a simulated 95% number of branches, and curve 306 approximates a simulated average number of branches.

Graphs 200, 300 and 400, include approximate curves based on computer simulations in which a time synchronization error was simulated (e.g., as a zero mean Gaussian random variable, of a standard deviation as found in the X axis of the plots), time synchronization errors were independently drawn for a master device and a slave device, and each simulation point is computed from Monte-Carlo simulations, with two hundred trials per point. The device receiver clocks were also simulated, with an Allan variance spectrum density of:

h₀=9.43 10⁻²⁰, h₋₁=1.8 10⁻¹⁹, h₋₂=3.8 10⁻²¹,

for example, corresponding to a standard quality TCXO (Temperature Compensated Crystal Oscillator). However, these graphs are intended for basic illustration purposes only.

Also, in this exemplary simulation (without necessarily limiting claimed subject matter), a maximum distance between two receiving devices was 100 meters per dimension. In this exemplary simulation, a total number of seconds per trial was 650.0 (e.g., limited for convenience by period of constant number of visible SVs, and constant reference SV, chosen at a highest elevation).

Thus, in at least this exemplary simulation, with regard to graph 200 of FIG. 2, one may notice that a maximum acceptable time synchronization error may be approximately 5.0 microseconds for no impact on ambiguity success rate, but a maximum of approximately 2.5 microseconds for substantially no impact on time to ambiguity fix and number of potential integer solutions (e.g., branches) to explore in LAMBDA (Least-squares AMBiguity Decorrelation Adjustment) and/or other like processing. Beyond 2.5 microseconds, both time to ambiguity fix and ambiguity search throughput may increase exponentially and/or increase significantly some other manner.

For example, a simple physics justification may be made as follows. For successful ambiguity resolution, in this example, a contribution of sampling time error to carrier phase measurement error for a single measurement may not be more than the carrier phase measurement noise (e.g., about 2.0 millimeters one sigma). Thus, in this example, for a maximum SV radial velocity of 800 meters/second, a maximum time uncertainty may not be more than:

$$\frac{2 \cdot {10}^{- 3}}{800} = 2.5 {10}^{- 6} seconds .$$

Hence, in this example, for a DD measurement, a maximum total combined SV velocity may still be about 800 m/s; a reference SV may be at zenith with almost no radial range variation, the other non-reference SV may have a radial velocity between 0 and 800 m/s, and an acceptable noise level may be about twice the single measurement. Thus, in this example, a maximum acceptable time uncertainty may be

$$\frac{4 {10}^{- 3}}{800} = 5 {10}^{- 6} seconds .$$

Continuing with this example, in graph 300, a maximum Time-To-Ambiguity-Fix may be approximately 10 s at 0.0 μs, and may jump to approximately 220 s at 5.0 μs. As shown in graph 400, in this example, the number of ambiguity hypotheses to explore before fix may jump from 20 at 0.0 μs to 1200 at 5.0 μs uncertainty.

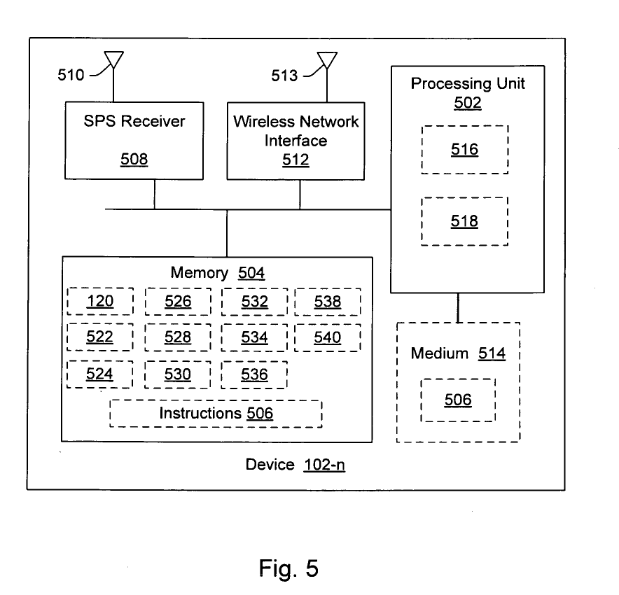

Attention is drawn next to FIG. 5, which is a block diagram illustrating certain features that may be implemented in one or more exemplary devices 102-n (or 104) of FIG. 1, for example.

As illustrated in this example, device 102-n may include one or more processing units 502, memory 504, an SPS receiver 508, and a wireless network interface 512. Device 102-n may also include one more antennas, such as, antenna 510 and/or antenna 513. Device 102-n may also include and/or otherwise operatively access a computer readable medium 514. As illustrated in this example, memory 504 and/or computer readable medium 514 may include computer implementable instructions 506 that may be implemented by processing unit 502 to perform certain actions, processes, and/or other like. For example, processing unit 502 may implement a synchronization process 516 in which synchronization information and/or other like data may be processed in some manner. For example, processing unit 502 may implement a carrier phase relative positioning process 518 in which various techniques as presented herein may be performed, at least in part.

SPS receiver 508 may, for example, be operatively enabled to acquire SPS signals through antenna 510 and provide code and carrier phase related information to processing unit 502 and/or memory 504. Wireless network interface 512 may, for example, be operatively enabled to transmit and receive wireless network signals via antenna 513. Information received by wireless network interface 512 may be provided to processing unit 502 and/or memory 504. Information to be transmitted by wireless network interface 512 may be provided by processing unit 502 and/or memory 504.

Processing unit 502 may be implemented in hardware, software, or a combination of hardware and software. Processing unit 502 may be representative of one or more circuits configurable to perform at least a portion of a data computing procedure or process. By way of example but not limitation, processing unit 502 may include one or more processors, controllers, microprocessors, microcontrollers, application specific integrated circuits, digital signal processors, programmable logic devices, field programmable gate arrays, and the like, or any combination thereof.

Memory 504 may be representative of any data storage mechanism. Memory 504 may include, for example, a primary memory and/or a secondary memory. Primary memory may include, for example, a random access memory, read only memory, etc. While illustrated in this example as being separate from processing unit 502, it should be understood that all or part of a primary memory may be provided within or otherwise co-located/coupled with processing unit 502. Secondary memory may include, for example, the same or similar type of memory as primary memory and/or one or more data storage devices or systems, such as, for example, a computer readable medium (e.g., a disk drive, an optical disc drive, a tape drive, a solid state memory drive, etc.).

As illustrated in FIG. 5, memory 504 may include message 102 related information, local receiver time information 522 (e.g., └T_{SPS-approx}┘), current chip number information 524 (e.g., N_{chip}^{k}), fraction of a chip information 526 (e.g., Δ_{chip}^{k}) SV transmit time information 528 (e.g., Tₜₛ^{k}, t_{s,slave}^{p}) carrier phase integer ambiguity information 530 (e.g., Nₜₛ^{k}, Nₛₗₐᵥₑ^{p}), cumulated carrier phase measurement information 532 (e.g., Φₛₗₐᵥₑ^{p}(t_{s,slave}^{p})), Double Difference (DD) Carrier Phase observable information 534, transmit time ambiguity information 536 (e.g., Nₛₗₐᵥₑ), single unknown parameter vector information 538, DD carrier phase linearization point information 540, and/or other like information (data) associated with processes 516, 518, or the like relating to techniques provided herein.

Certain exemplary techniques in accordance with certain aspects of the present description will now be described in greater detail regarding certain exemplary algorithmic strategies and/or functions.

In certain known systems, a satellite k transmit time (Tₜₛ^{k}) may be obtained by counting a number of 20 ms complete navigation message bits (N_{bit}^{k}), then a number of 1.0 ms complete spread spectrum sequences (N_{PRN}^{k}), then a number of chips in a spread-spectrum sequence (N_{chip}^{k}), and finally a fraction of spread spectrum chip (Δ_{chip}^{k}) after a last identified Z-count number (TOW^{k}).

Tₜₛ^{k}=TOW^{k}+20.10⁻³·N_{bit}^{k}+10⁻³·N_{PRN}^{k}+10⁻⁶·N_{chip}^{k}+10⁻⁶·Δ_{chip}^{k}

One may substitute this transmit time determination by adding to an approximate slave device (receiver) time (a local receiver time), e.g., rounded to the nearest millisecond (└_{SPS-approx}┘) a current chip number (e.g., in a current 1.0 ms PRN sequence) (N_{chip}^{k}), and a fraction of chip at the time of the carrier phase measurements sampling (Δ_{chip}^{k}). This time (e.g., an SV transmit time) may be significantly accurate (e.g., if the code measurement is made at a 2.0 meters one sigma accuracy, it may be less than 7.0 ns), but ambiguous by an unknown number of milliseconds (Nₜₛ^{k}) (e.g., a carrier phase integer ambiguity).

Tₜₛ^{k}=└T_{SPS-approx}┘+10⁻⁶·N_{chip}^{k}+10⁻⁶·Δₜₛ^{k}+10⁻³·Nₜₛ^{k}

In known relative carrier phase positioning systems, Carrier Phase Measurements may be modeled as:

Φ_{receiver}^{p}(tᵣ)=P_{receiver}^{p}(tᵣ)+λ₁.N_{receiver}^{p}−c.dt_{receiver}+c.dt^{p}+l_{receiver}^{p}(tᵣ)+T_{receiver}^{p}(tᵣ)+δ_{r,receiver}^{p}(tᵣ)+ε₁₀₁

Here, for example, let:
Φ_{receiver}^{p}(tᵣ) be the cumulated carrier phase (in meters) between p SV and receiver, time tagged at received time tᵣ;
P_{receiver}^{p}(tᵣ) be a geometric range from p SV to receiver (in meters);
λ₁ be the (e.g., L1) signal wavelength (in meters);
N_{receiver}^{p} be a carrier phase integer ambiguity (number of wavelengths);
c be velocity of light (in meters/second);
dt_{receiver} be a Receiver Clock Offset (in seconds);
dt^{p} be p SV Clock Offset (in seconds), e.g., a difference between p SV clock error and SPS system time which may be found in the broadcast ephemeris;
t_{receiver}^{p}(tᵣ) be an ionospheric extra delay (in meters);
T_{receiver}^{p}(tᵣ) be a tropospheric extra delay (in meters);
δ_{r,receiver}^{p}(tᵣ) be a multipath error at the receiver (in meters); and,
ε₁₀₁ be a measurement of noise (in meters).

In this example, all variables may be referred to the common known receive time tᵣ at master (receiver) device. This may be implemented as a model for master receiver observables.

As a slave receiver device observable may be time tagged in transmit time (e.g., different for each SV, even if the receive time may be identical), one may employ a different expression that uses the transmit time t_{s,slave}^{p} from the p satellite to slave receiver as an independent variable:

Φₛₗₐᵥₑ^{p}(t_{s,slave}^{p})=pₛₗₐᵥₑ^{p}(t_{s,slave}^{p})+λ₁.Nₛₗₐᵥₑ^{p}−c.dtₛₗₐᵥₑ+c.dt^{p}+lₛₗₐᵥₑ^{p}(t_{s,slave}^{p})+Tₛₗₐᵥₑ^{p}(t_{s,slave}^{p})+δₛₗₐᵥₑ^{p}(t_{s,slave}^{p})+ε_{Φ}

Here, for example, let:
t_{s,slave}^{p} be a transmit time (e.g., SV transmit time) from p SV for the signal received at slave receiver;
Φₛₗₐᵥₑ^{p} (t_{s,slave}^{p}) be a cumulated carrier phase measurement at slave receiver (in meters);
pₛₗₐᵥₑ^{p}(t_{s,slave}^{p}) be geometric distance from p SV to slave receiver (in meters);
λ₁ be the (e.g., L1) signal wavelength (in meters);
Nₛₗₐᵥₑ^{p} be the carrier phase integer ambiguity (number of wavelengths); c be the velocity of light (in m/s);
dtₛₗₐᵥₑ be the difference between receiver clock error and SPS system time at receive time (in seconds);.
dt^{P} be the difference between p SV clock error and SPS system time, e.g., may be found in the broadcast ephemeris (in seconds);
l_{slave,}^{p}(t_{s,slave}^{p}) be the ionospheric delay at transmit time t_{s,slave}^{p} of the distance between p SV and slave receiver (in meters);
Tₛₗₐᵥₑ^{p}(t_{s,slave}^{p}) be the tropospheric delay at transmit time t_{s,slave}^{p} of the distance between p SV and slave receiver (in meters);
δₛₗₐᵥₑ^{p}(t_{s,slave}^{p}) be a hardware delay and multipath effects on the (e.g., L1) carrier phase (in meters); and,
ε_{Φ} be the (e.g., L1) carrier phase measurement noise (in meters).

Such may be combined into Double Difference Carrier Phase observables (e.g., differencing the measurements between receivers and then between SVs) for elimination of common mode errors at the receivers (dt_{receiver}, l_{receiver}^{p}, T_{receiver}^{p}) and at the SVs (dt^{p}). Thus, for example:

φₘₛ^{pq}=Φₘ^{p}−Φₛ^{p}−Φₘ^{q}+Φₛ^{q}

Here, for example, let:
Φₘ^{p} be a cumulated carrier phase between p SV and master receiver (m), and
Φₛ^{p} be a cumulated carrier phase between q SV and slave receiver (s).

An SV may be selected as a “reference satellite” (e.g., an SV currently having the highest elevation may be selected), and all the other measurements may be expressed as measurement differences with regard to the reference satellite.

For M number of SVs with valid measurements, M−1 valid DD carrier phase observables may be derived. However, given the ambiguous nature of carrier phase measurements, each DD carrier phase observable may include an unknown term equal to an integer number of wavelengths (e.g., about 19.0 cm for L1 GPS).

To resolve a relative position between master and slave receivers as a baseline Δx, Δy, Δz between receivers in Earth Centered, Earth Fixed (ECEF) coordinates, each integer ambiguity in carrier phase may be resolved. Here, for example, each DD carrier phase observable may be expressed at common receive time and linearized around a master position as may be expressed as a Taylor series expansion:

$${Φ}_{m s}^{pq} ( {x}_{0} + Δ x , {y}_{0} + Δ y , {z}_{0} + Δ z , {N}_{m s}^{pq} ) = {Φ}_{m s}^{pq} ( {t}_{r} , {x}_{0} , {y}_{0} , {z}_{0} ) + \frac{\partial {Φ}_{m s}^{pq}}{\partial x} \cdot Δ x + \frac{\partial {Φ}_{m s}^{pq}}{\partial y} \cdot Δ y + \frac{\partial {Φ}_{m s}^{pq}}{\partial z} \cdot Δ z + {λ}_{1} \cdot {N}_{m s}^{pq}$$

Here, for example, let:
Φₘₛ^{pq}(tᵣ, x₀, y₀, z₀) be DD carrier phase linearization point (at master coordinates x₀, y₀, z₀ and common receive time tᵣ);
Δx, Δy, Δz be relative position differences between slave and master positions;

$$\frac{\partial {Φ}_{m s}^{pq}}{\partial x} , \frac{\partial {Φ}_{m s}^{pq}}{\partial y} , \frac{\partial {Φ}_{m s}^{pq}}{\partial z}$$

be partial derivatives of DD carrier phase with regard to relative position coordinates;
λ₁ be the (e.g., L1) signal wavelength (in meters); and,
Nₘₛ^{pq} be the OD integer ambiguity.
Where, e.g., p, q, m, and s refer, respectively, to reference satellite, non reference satellite, master receiver, and slave receiver.

In accordance with certain aspects of the present description, a unique transmit time ambiguity (e.g., Nₛₗₐᵥₑ, in 1.0 ms ambiguities) may be combined along with all the DD ambiguities (e.g., Nₘₛ^{pq} in wavelengths) as a single unknown parameter vector. Such a resulting unknown parameter vector may allow for a simultaneous resolution, for example, by using one or more known integer ambiguity techniques. Thus, for example, the Taylor series expansion becomes:

$${Φ}_{m s}^{pq} ( {x}_{0} + Δ x , {y}_{0} + Δ y , {z}_{0} + Δ z , {N}_{slave} , {N}_{m s}^{pq} ) = {Φ}_{m s}^{pq} ( {t}_{s , slave , 0}^{p} , {t}_{s , slave , 0}^{q} , {t}_{r , master} , {x}_{0} , {y}_{0} , {z}_{0} ) + \frac{\partial {Φ}_{m s}^{pq}}{\partial x} , Δ x + \frac{\partial {Φ}_{m s}^{pq}}{\partial y} , Δ y + \frac{\partial {Φ}_{m s}^{pq}}{\partial z} , Δ z + \frac{\partial {Φ}_{m s}^{pq}}{\partial N} \cdot {N}_{slave} + {λ}_{1} \cdot {N}_{m s}^{pq}$$

Here, for example, let:
the additional variables Φₘₛ^{pq}(t_{s,slave,0}^{p}, t_{s,slave,0}⁰, t_{r,master}, x₀, y₀, z₀) be DD carrier Phase linearization point, at master coordinates x₀, y₀, z₀, at common receive time (t_{r,master}) at master and multiple transmit times at slave (t_{s,slave,0}^{p},t_{s,slave,0}^{q}); and, Nₛₗₐᵥₑ be reference satellite transmit time integer ambiguity at a slave.

As mentioned earlier, in certain example implementations, master receiver measurements may be referenced to a (unique) receive time, whereas slave receiver measurements may be referenced to (multiple) transmit times. In order to introduce only one unknown time ambiguity, a transmit time difference in nearest integer milliseconds between reference satellite and all the other ones at slave receiver may be derived, for example, either from master receiver measurements, and/or by computing the expected geometric ranges at a neighboring Base Station or other like device location. Some additional details about some exemplary linearized equations are presented in subsequent sections herein.

An example ambiguity resolution technique may then be implemented in a multiple-stage and/or other like process. In an exemplary first stage, an approximate solution may be found in the real float number domain for all the integer parameters along with associated covariances. At the outcome of this first stage, some float values may or may not be integer values. In an exemplary second stage, an accurate time ambiguity, along with the associated DD ambiguities, may then be established by applying a Least squares AMBiguity Decorrelation Adjustment (LAMBDA) and/or other like technique, which may reduce or limit the residuals in the integer domain, taking into account mutual correlations. The correct ambiguities may then be re-injected into the formula and the relative distances ΔX, ΔY, and ΔZ may be derived as a final solution.

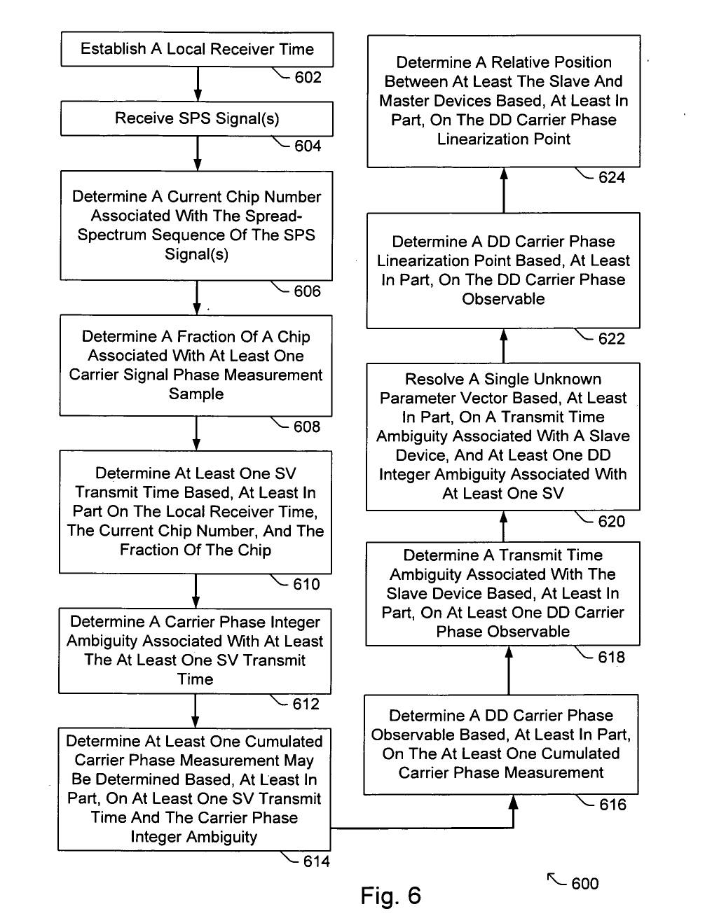

Attention is now drawn to FIG. 6, which includes a flow-diagram that may be implemented in a device 102-n, for example. Here, block 602 may be associated with process 516 (see FIG. 5) and one or more of blocks 604 through 622 may be associated with process 518, for example.

At block 602, a local receiver time may be established. For example, synchronization information may be received and/or otherwise accessed.

At block 604, SPS signal(s) may be received and acquired. At block 606, a current chip number associated with a spread-spectrum sequence of SPS signal(s) may be determined. At block 608, a fraction of a chip associated with at least one carrier signal phase measurement sample may be determined. At block 610, at least one SV transmit time may be determined based, at least in part, on the local receiver time, the current chip number, and the fraction of the chip.

At block 612, a carrier phase integer ambiguity associated with at least one SV transmit time may be determined. At block 614 at least one cumulated carrier phase measurement may be determined based, at least in part, on the at least one SV transmit time and the carrier phase integer ambiguity.

At block 616, a DD Carrier Phase observable may be determined based, at least in part, on the at least one cumulated carrier phase measurement. At block 618, a transmit time ambiguity associated with slave device (receiver) may be determined based, at least in part, on at least one DD Carrier Phase observable. At block 620, a single unknown parameter vector may be resolved based, at least in part, on a transmit time ambiguity associated with a slave device, and at least one DD integer ambiguity associated with at least one SV. At block 622, a DD carrier phase linearization point may be determined based, at least in part, on the DD carrier phase observable. At block 624, a relative position between at least slave and master devices may be determined based, at least in part, on the DD carrier phase linearization point.

In accordance with certain aspects of the present description techniques provided herein may, for example, be implemented in a peer-to-peer system arrangement wherein a master device (receiver) comprises a more robust and/or otherwise adequately implemented SPS receiver capability that may collects Broadcast Ephemeris, and determines its own absolute position and clock error. Master device (receiver) may be adapted to synchronize the time in a slave device (receiver) by sending a time tagging message through at least one wireless connection link, however, as described herein, such synchronization process may have an accuracy that may be too low to allow for successful ambiguity resolution. Compared to master device (receiver) slave device (receiver) may have reduced and/or otherwise limited SPS processing capabilities. Such a slave device (receiver) may, however, be adapted to collect code offset and Cumulated Carrier Phase information.

In accordance with certain aspects of the present description techniques provided herein may, for example, be implemented in a base station (or other like device) system arrangement. Here, for example, two or more mobile stations (receivers) may be wirelessly connected to a particular base station and synchronized in time with SPS system time to a particular accuracy (e.g., approximately 10-50 microseconds). Such synchronization accuracy may not, however, be sufficient to assume quasi simultaneity of the measurements at each mobile station (receiver), to allow fast ambiguity resolution. Satellite Ephemeris and approximate absolute position may be provided to both of the mobile stations (receivers) by the base station. Based, at least in part, on at least a portion of the exemplary techniques provided herein an algorithm and/or other like logic may be adapted in each of the mobile stations (receivers) to resolve a received time difference between both mobile stations (receivers) and to allow an accurate (e.g., cm level) relative positioning to be determined.

In accordance with certain aspects of the present description techniques provided herein may provide a benefit with regard to weak signals. For example, an exemplary slave device may effectively operate in an environment having weak SPS signals as it may not be reliant on navigation message data demodulation. Here, instead, the quality of the carrier phase measurements may be assessed in such an environment. Thus, if an SPS signal is so weak as to prevent data demodulation, the quality of the time synchronization by Unknown Transmit Time Algorithm Resolution (e.g., 10.0 ms) or by direct synchronization (e.g., 10.0-50.0 μs) may be insufficient for successful ambiguity resolution without employing, for example, techniques provided herein.

In accordance with certain aspects of the present description techniques provided herein may provide a benefit with regard to accuracy of position measurements. For example, techniques provided herein may be implemented to provide for relative positioning accuracy at the centimeter level. The loss of solution strength that such techniques may introduce in some implementations by having to estimate an extra parameter, may however be compensated for by the extra constraint of the integer nature of the parameter.

In accordance with certain aspects of the present description techniques provided herein may provide a benefit with regard to large-time transfer errors. For example, an error that is introduced by direct time transfer from a Base Station to a receiving device using a CDMA pilot phase offset technique may have a delay as large as 10-50 microseconds, due to the lack of compensation of the propagation time. This may be unacceptable for ambiguity resolution in certain implementations. Techniques provided herein, however, may be implemented in a process or the like that accommodates much larger time uncertainties (e.g., at least 100.0 ms).

In accordance with certain aspects of the present description techniques provided herein may provide a benefit with regard to establishing an accurate receive time without and/or with less data demodulation. For example, techniques provided herein may be implemented such that the transmit time may be very accurate having taken advantage of the integer nature of the 1.0 ms ambiguity, and the receive time at slave may be as accurate.

In accordance with certain aspects of the present description techniques provided herein may provide a benefit with regard to devices that are moved or moving about. While the examples above are associated with static situations, it should be clear that techniques provided herein may be, and are intended to be, implemented for environments capable of having moving device(s). By way of further example but not limitation, techniques provided herein may be implemented for use in Real Time Kinematic (RTK) systems wherein cycle slips are substantially avoided and/or otherwise reliably detected/corrected upon occurrence.

In accordance with certain aspects of the present description techniques provided herein may provide a benefit with regard to a fast-time-to-fix determination. For example, for distances of 3.0-5.0 km between devices, techniques provided herein may be implemented to consider that the ionospheric correction may is highly correlated and the ambiguities resolution may be completed quickly (e.g., within about 5.0-10.0 seconds in certain example implementations).

In accordance with certain aspects of the present description techniques provided herein may provide a benefit with regard to devices having limited processing capabilities. For example, techniques provided herein may be implemented such that there may be little if any need for a slave device to perform a systematic explicit search in the time ambiguity domain. Instead, in certain implementations, a LAMBDA or other like process may be adapted to automate this part and avoid a suboptimal “ad-hoc” search implementation. Techniques provided herein may also be implemented to drastically reduce a search space, as such techniques may be adapted to start from float values that may already be quite close of final integer values, which may allow for a search domain to be reduced as a covariance matrix may act to limit the search ranges in all dimensions.

In accordance with certain aspects of the present description techniques provided herein may be particularly useful if two receiving devices may be within approximately 5.0 km from one another, and possibly even more useful when the two receiving devices may be within approximately 3.0-5.0 km from one another. However, subject matter claimed herein is not necessarily intended to be limited in this manner.

In accordance with certain aspects of the present description techniques provided herein may be particularly useful in a system wherein approximate coordinates of the area (e.g., within 3.0-5.0 km) may be available (e.g., either as coordinates of a Base Station in an A-GPS scenario or single position computation done at a master device). Again, however, subject matter claimed herein is not necessarily intended to be limited in this manner.

In accordance with certain aspects of the present description techniques provided herein may be particularly useful if a master device is aware of SPS system time to a specified accuracy (e.g., within 1.0 microsecond). In certain implementations, this may imply that a single position computation be conducted at master device (receiver), as a wireless synchronization scheme, for example, associated with a Base Station may not be accurate enough. Hereto, however, subject matter claimed herein is not necessarily intended to be limited in this manner.

In accordance with certain aspects of the present description techniques provided herein may be particularly useful if cumulated carrier phase measurements at master device (receiver) may be substantially, if not perfectly, synchronous. Similarly, techniques provided herein may be particularly useful if cumulated carrier phase measurement at slave device (receiver) may be substantially, if not perfectly, synchronous, but not necessarily synchronous with master device (receiver). However, subject matter claimed herein is not necessarily intended to be limited in this manner.

In accordance with certain aspects of the present description techniques provided herein may be particularly useful if carrier phase measurement related noise may be approximately 1-2 millimeters or less (e.g., consider all or several effects, including measurement resolution). This may be beneficial for carrier phase positioning while not necessarily being specific to an implemented process. Hence, subject matter claimed herein is not necessarily intended to be limited in this manner.

Those skilled in the art will recognize that linearized equations may be implemented as part of an algorithm as part of techniques provided herein. By way of example but not limitation a simplified version of some example linearized equations is provided below.

Here, for example, given:

B=A.X

An increment measurement vector B may be provided as:

$$B = [ \begin{matrix}{Φ}_{m s}^{12} ( x , y , z , {N}_{slave} ) - {Φ}_{m s}^{12} ( {t}_{s , slave , 0}^{1} , {t}_{s , slave , 0}^{2} , {t}_{r , master} ) \\ ⋮ \\ {Φ}_{m s}^{1 M} ( x , y , z , {N}_{slave} ) - {Φ}_{m s}^{1 M} ( {t}_{s , slave , 0}^{1} , {t}_{s , slave , 0}^{M} , {t}_{r , master} )\end{matrix} ]$$

Here, for example, let:
Φₘₛ¹²(x,y,z,Nₛₗₐᵥₑ) be an actual DD Carrier Phase measurement, and
Φₘₛ¹²(t_{s,slave,0}¹, t_{s,slave,0}², t_{r,master}) be an estimated DD Carrier Phase measurement.

Here, for example, slave device (receiver) DD Carrier phase estimates may be made at estimated transmit time t_{s,slave,0}¹ for an SV 1, and estimated transmit time t_{s,slave,0}² for an SV 2. Master device (receiver) Carrier Phase estimates may be made at the known common receive time at master, t_{r,master}.

Thus, for example, a design matrix A may be presented as:

$$A = [ \begin{matrix}\frac{\partial {Φ}_{m s}^{12}}{\partial x} & \frac{\partial {Φ}_{m s}^{12}}{\partial y} & \frac{\partial {Φ}_{m s}^{12}}{\partial z} & \frac{\partial {Φ}_{m s}^{12}}{\partial {N}_{slav e}} & {λ}_{1} & 0 & … & … & 0 \\ ⋮ & ⋮ & ⋮ & ⋮ & 0 & {λ}_{1} & ⋰ & & ⋮ \\ ⋮ & ⋮ & ⋮ & ⋮ & ⋮ & ⋰ & {λ}_{1} & ⋰ & ⋮ \\ ⋮ & ⋮ & ⋮ & ⋮ & ⋮ & & ⋰ & {λ}_{1} & 0 \\ \frac{\partial {Φ}_{m s}^{1 M}}{\partial x} & \frac{\partial {Φ}_{m s}^{1 M}}{\partial y} & \frac{\partial {Φ}_{m s}^{1 M}}{\partial y} & \frac{\partial {Φ}_{m s}^{1 M}}{\partial {N}_{slave}} & 0 & … & … & 0 & {λ}_{1}\end{matrix} ]$$

An unknown parameters vector (e.g., mixed float and integer) may be presented as:

X^{t}=[Δx Δy Δz Nₛₗₐᵥₑ¹ Nₘₛ¹² . . . Nₘₛ^{1M}],
where Nₛₗₐᵥₑ¹ is the “approximate transmit time t_{s,slave}^{approx}” integer ms correction of a signal received at slave from sat 1;
Nₛₗₐᵥₑⁿ is the “approximate transmit time t_{s,slave}^{approx}” integer ms correction of a signal received at slave from sat n; and
Nₛₗₐᵥₑ¹ⁿ is the difference Nₛₗₐᵥₑⁿ, Nₛₗₐᵥₑ¹.
   Here, for example, let Δx, Δy, Δz be relative position differences of a slave device with respect to a master device's position, thus: Nₛₗₐᵥₑ¹ may be a reference SV transmit time integer ambiguity at a slave device (receiver); Nₘₛ¹² may be a DD Carrier Phase Ambiguity between SV1/SV2, and master-device/slave-device receivers; and, Nₘₛ^{1M} may be a DD Carrier Phase Ambiguity between SV1/SVM, and master-device/slave-device receivers.

In accordance with certain aspects of the present description, techniques provided herein may be adapted to determine transmit times at a slave device (receiver), such as, e.g., a transmit time at an SV for an SPS signal that is received by a slave device (receiver). For example, an average transmit time at an SV for an SPS signal received at a slave device (receiver) may be equal to a received time (i.e. sampling time) minus average geometric distance converted into time by multiplication with velocity of light, which may then be corrected by ionospheric and tropospheric delays. Thus, rounded to the nearest millisecond, the approximate transmit time of all SVs received at slave device (receiver) rounded to the next millisecond may be:

$${t}_{s , slave}^{approx} = round [ \frac{( {t}_{sync , slave} - {t}_{flight} )}{{10}^{- 3}} ] \cdot {10}^{- 3}$$

Here, for example, let:
t_{s,slave}^{approx} be an approximate SPS transmit time for all signals received at a slave device (receiver) rounded as an integer number of milliseconds (in seconds);
t_{sync,slave} be a time at the slave device (receiver) synchronized from a master device (receiver) (in seconds); and
t_{flight} may be a SV-receiver average time of flight (e.g., t_{flight}≈75·10⁻³ s) (in seconds).

In the example formula above, the flight time may be approximated by an average value of 75 milliseconds to reduce the asymmetry of the range of values that Nₛₗₐᵥₑ¹ may take, but it may not be mandatory to compensate for it. In certain implementations, an adjustment procedure may be provided to compensate, as may be desired, for such approximation/error.

In an exemplary Carrier Phase Double Differencing technique, the SVs may be divided between a reference SV and other (non-reference) SVs. In a single differencing operation, every measurement of integrated (e.g., cumulated) carrier phase for non-reference SV may be subtracted from the reference carrier phase measurement. In the following sections, “reference SV” refers to the same SV as the “reference satellite” in the double differencing operation.

The reference SV transmit time of a signal received at slave device (receiver) may be substantially if not precisely expressed in seconds from the beginning of the week (here, e.g., the reference SV SPS system time error may be assumed to have been already corrected), such that:

t_{s,slave}¹=t_{s,slave}^{approx}+Nₛₗₐᵥₑ¹·10⁻³+C_{r,slave}¹·10⁻³−dt₁,

Here, for example, let:
t_{s,slave}¹ be a reference (e.g., first) SV transmit time received at a slave device (receiver) (in seconds);
t_{s,slave}^{approx} be an approximate SPS system time at the slave device (receiver) as an integer number of milliseconds (in seconds);
Nₛₗₐᵥₑ¹ be an integer number of milliseconds of correction of t_{s,slave}^{approx} applicable for the transmit time of the Reference SV (no units);
C_{r,slave}¹ be a sub millisecond code offset of the Reference SV at the slave device (receiver) in fraction of one millisecond (no units); and
dt₁ be a REF SV clock error with regard to SPS system time (e.g., which may be found in the broadcast ephemeris)(in seconds).

In accordance with certain aspects of the present description, techniques provided herein may be adapted to determine transmit times at a slave device (receiver), such as, e.g., inter-SV transmit time differences at a slave device (receiver) as derived, at least in part, using a master device (receiver).

To avoid to introducing more unknown integer ms variables, all non-reference SV transmit times for a slave device (receiver) may be expressed as a difference between a transmit time at the n^{th} SV and a transmit time at the reference SV. Here, in certain implementations, it may be that only the 1.0 ms integer offset may be needed, as the code offsets may determine the sub-millisecond section.

The integer transmit time differences at slave device (receiver) Nₛₗₐᵥₑ¹ⁿ may, for example, be determined, at least in part, from integer transmit time differences at master device (receiver) as measured and/or otherwise computed.

Thus, for example,

Nₘₐₛₜₑᵣ¹ⁿ=round[(t_{s,master}ⁿ·10³−C_{r,master}ⁿ)−(t_{s,master}¹·10³−C_{r,master}¹)].

Here, for example, let:,
Nₘₐₛₜₑᵣ¹ⁿ be the integer number of milliseconds between n^{th} SV code offset reference point and first (e.g., reference) SV code offset point (no units);
t_{s,Master}ⁿ be the transmit time of the n^{th} SV received at a master device (receiver)(in seconds);
C_{r,Master}ⁿ be the sub-millisecond code offset for the n^{th} SV in fractions of one millisecond (no units);
t_{s,Master}¹ be the transmit time of the first SV received at the master device (receiver)(in seconds); and,
C_{r,Master}¹ be the sub-millisecond code offset for the n^{th} SV in fractions of one millisecond (no units).

Similarly, in certain example implementations, SV transmit times of all remaining M−1 signals received at slave device (receiver) may be expressed as:

$${t}_{s , slave}^{2} = {t}_{s , slave}^{1} - {C}_{r , slave}^{1} \cdot {10}^{- 3} + {dt}_{1} + {N}_{slave}^{12} \cdot {10}^{- 3} + {C}_{r , slave}^{2} \cdot {10}^{- 3} - {dt}_{2}$$

$$⋮$$

$${t}_{s , slave}^{( M - 1 )} = {t}_{s , slave}^{1} - {C}_{r , slave}^{1} \cdot {10}^{- 3} + {dt}_{1} + {N}_{slave}^{1 ( M - 1 )} \cdot {10}^{- 3} + {C}_{r , slave}^{( M - 1 )} \cdot {10}^{- 3} - {dt}_{( M - 1 )}$$

Here, for example, let:
t_{s,slave}¹ be a reference (e.g., first) SV transmit time received at a slave device (receiver)(in seconds);
C_{r,slave}¹ be the sub-millisecond code offset of the first non-reference SV at the slave device (receiver) in fractions of one millisecond(no units);
t_{s,slave}^{(M-1)} be the (M−1)^{th} SV transmit time received at the slave device (receiver)(in seconds);

Nₛₗₐᵥₑ¹² be the integer number of milliseconds of correction of second SV transmit time at the slave device (receiver) minus Reference SV transmit time(no units);

C_{r,slave}² be the sub-millisecond code offset of the first non-reference SV at the slave device (receiver) in fractions of one millisecond(no units);

C_{r,slave}^{(M-1)} be the sub-millisecond code offset of the (M−1)^{th} non-reference SV at the slave device (receiver) in fractions of one millisecond(no units); and,
dt₂, . . . dt_{M-1} be the differences between the 2^{nd} to (M−1)^{th} SVs' clock errors with regard to SPS system time (e.g., which may be found in the broadcast ephemeris)(in seconds).

In accordance with certain aspects of the present description, in certain implementations the same and only unknown in all of such exemplary formulas may be the integer Nₛₗₐᵥₑ¹.

However, it should be recognized that the difference Nₛₗₐᵥₑ¹ⁿ between Nₛₗₐᵥₑ¹ and Nₛₗₐᵥₑⁿ may, for example, be approximated as the rounded millisecond integer part of transmit time difference at a master device (receiver) between the Reference SV and an SV of interest. This estimation may be valid if the distance between master device (receiver) and slave device (receiver) may be less than (or significantly less than) 300 km (e.g., or 1 millisecond in time equivalent), and SPS time difference between if the estimation may have been done at the master device (receiver) and used at the slave device (receiver) is less than, e.g., 300 km/4/3.5 km/s≈20 seconds.

In the above examples, the transmit times may be expressed in terms of the only unknown Nₛₗₐᵥₑ¹. Thus, for example:

$${t}_{s , slave}^{1} = {t}_{s , slave}^{approx} + {N}_{slave}^{1} \cdot {10}^{- 3} + {C}_{r , slave}^{1} \cdot {10}^{- 3} - {dt}_{1}$$

$${t}_{s , slave}^{2} = {t}_{s , slave}^{approx} + {N}_{slave}^{1} \cdot {10}^{- 3} + {N}_{slave}^{12} \cdot {10}^{- 3} + {C}_{r , slave}^{2} \cdot {10}^{- 3} - {dt}_{2}$$

$$⋮$$

$${t}_{s , sla ve}^{( M - 1 )} = {t}_{s , slave}^{approx} + {N}_{slave}^{1} \cdot {10}^{- 3} + {N}_{slave}^{1 ( M - 1 )} \cdot {10}^{- 3} + {C}_{r , slave}^{( M - 1 )} \cdot {10}^{- 3} - {dt}_{( M - 1 )}$$

While there has been illustrated and described what are presently considered to be example features, it will be understood by those skilled in the art that various other modifications may be made, and equivalents may be substituted, without departing from claimed subject matter. Additionally, many modifications may be made to adapt a particular situation to the teachings of claimed subject matter without departing from the central concept described herein.

Therefore, it is intended that claimed subject matter not be limited to the particular examples disclosed, but that such claimed subject matter may also include all aspects falling within the scope of appended claims, and equivalents thereof.

What is claimed is:

1. A method for use with a device having an SPS receiver, the method comprising:
determining a current chip number associated with a spread-spectrum sequence in at least one received Satellite Positioning System (SPS) signal transmitted by at least one space vehicle (SV);
determining a fraction of a chip associated with at least one carrier signal phase measurement sample; and
determining at least one SV transmit time based, at least in part on a local receiver time, said current chip number, and said fraction of said chip.

2. The method as recited in claim 1, further comprising:
determining a carrier phase integer ambiguity associated with at least said at least one SV transmit time.

3. The method as recited in claim 2, further comprising:
determining at least one cumulated carrier phase measurement based, at least in part, on said at least one SV transmit time and said carrier phase integer ambiguity.

4. The method as recited in claim 3, further comprising:
determining a Double Difference (DD) Carrier Phase observable based, at least in part, on said at least one cumulated carrier phase measurement.

5. The method as recited in claim 4, wherein said DD Carrier Phase observable is associated, at least in part, with at least one other receiver of at least one other device.

6. The method as recited in claim 5, wherein said local receiver is associated with a slave receiver and said at least one other device comprises a master device.

7. The method as recited in claim 6, wherein said slave and master devices are operatively coupled together through at least a portion of a wireless network.

8. The method as recited in claim 6, further comprising:
establishing said local receiver time based, at least in part, on synchronization information associated with said master device.

9. The method as recited in claim 6, wherein said master device and said at least one SV are substantially synchronized to an SPS system time.

10. The method as recited in claim 4, further comprising:
determining a transmit time ambiguity associated with said slave device based, at least in part, on at least one DD Carrier Phase observable; and
resolving a single unknown parameter vector based, at least in part, on a transmit time ambiguity associated with said slave device, and at least one DD integer ambiguity associated with at least said at least one SV.

11. The method as recited in claim 4, further comprising:
determining a OD carrier phase linearization point based, at least in part, on said DD carrier phase observable; and
determining a relative position between at least said slave and master devices based, at least in part, on said DD carrier phase linearization point.

12. An apparatus comprising:
means for determining a current chip number associated with a spread-spectrum sequence in at least one received Satellite Positioning System (SPS) signal transmitted by at least one space vehicle (SV);
means for determining a fraction of a chip associated with at least one carrier signal phase measurement sample; and
means for determining at least one SV transmit time based, at least in part on a local receiver time, said current chip number, and said fraction of said chip.

13. The apparatus as recited in claim 12, further comprising:
means for determining a carrier phase integer ambiguity associated with at least said at least one SV transmit time.

14. The apparatus as recited in claim 13, further comprising:
means for determining at least one cumulated carrier phase measurement based, at least in part, on said at least one SV transmit time and said carrier phase integer ambiguity).

15. The apparatus as recited in claim 14, further comprising:
means for determining a Double Difference (DD) Carrier Phase observable based, at least in part, on said at least one cumulated carrier phase measurement.

16. The apparatus as recited in claim 15, wherein said DD Carrier Phase observable is associated, at least in part, with at least one other receiver of at least one other device.

17. The apparatus as recited in claim 16, wherein said local receiver is associated with a slave receiver and said at least one other device comprises a master device.

18. The apparatus as recited in claim 17, further comprising:
means for operatively coupling said slave and master devices together.

19. The apparatus as recited in claim 17, further comprising:
means for establishing said local receiver time based, at least in part, on synchronization information associated with said master device.

20. The apparatus as recited in claim 17, wherein said master device and said at least one SV are substantially synchronized to an SPS system time.

21. The apparatus as recited in claim 15, further comprising:
means for determining a transmit time ambiguity associated with said slave device based, at least in part, on at least one DD Carrier Phase observable; and
means for resolving a single unknown parameter vector based, at least in part, on a transmit time ambiguity associated with said slave device, and at least one DD integer ambiguity associated with at least said at least one SV.

22. The apparatus as recited in claim 15, further comprising:
means for determining a DD carrier phase linearization point based, at least in part, on said DD carrier phase observable; and
means for determining a relative position between at least said slave and master devices based, at least in part, on said DD carrier phase linearization point.

23. An article comprising:
a computer readable medium having stored thereon computer implementable instructions that if implemented by one or more processing units operatively enable the one or more processing unit to:
determine a current chip number associated with a spread-spectrum sequence in at least one received Satellite Positioning System (SPS) signal transmitted by at least one space vehicle (SV);
determine a fraction of a chip associated with at least one carrier signal phase measurement sample; and
determine at least one SV transmit time based, at least in part on a local receiver time, said current chip number, and said fraction of said chip.

24. The article as recited in claim 23, wherein the computer implementable instructions, if implemented by one or more processing units, operatively enable the one or more processing unit to:
determine a carrier phase integer ambiguity associated with at least said at least one SV transmit time.

25. The article as recited in claim 24, wherein the computer implementable instructions, if implemented by one or more processing units, operatively enable the one or more processing unit to:
determine at least one cumulated carrier phase measurement based, at least in part, on said at least one SV transmit time and said carrier phase integer ambiguity.

26. The article as recited in claim 25, wherein the computer implementable instructions, if implemented by one or more processing units, operatively enable the one or more processing unit to:
determine a Double Difference (DD) Carrier Phase observable based, at least in part, on said at least one cumulated carrier phase measurement.

27. The article as recited in claim 26, wherein said DD Carrier Phase observable is associated, at least in part, with at least one other receiver of at least one other device.

28. The article as recited in claim 27, wherein said local receiver is associated with a slave receiver and said at least one other device comprises a master device.

29. The article as recited in claim 28, wherein said slave and master devices are operatively coupled together through at least a portion of a wireless network.

30. The article as recited in claim 28, wherein the computer implementable instructions, if implemented by one or more processing units, operatively enable the one or more processing unit to:
establish said local receiver time based, at least in part, on synchronization information associated with said master device.

31. The article as recited in claim 28, wherein said master device and said at least one SV are substantially synchronized to an SPS system time.

32. The article as recited in claim 26, wherein the computer implementable instructions, if implemented by one or more processing units, operatively enable the one or more processing unit to:
determine a transmit time ambiguity associated with said slave device based, at least in part, on at least one DD Carrier Phase observable; and
resolve a single unknown parameter vector based, at least in part, on a transmit time ambiguity associated with said slave device, and at least one DD integer ambiguity associated with at least said at least one SV.

33. The article as recited in claim 26, wherein the computer implementable instructions, if implemented by one or more processing units, operatively enable the one or more processing unit to:
determine a DD carrier phase linearization point based, at least in part, on said DD carrier phase observable; and
determine a relative position between at least said slave and master devices based, at least in part, on said DD carrier phase linearization point.

34. An apparatus comprising:
a receiver operatively enabled to acquire at least one SPS signal associated with a spread-spectrum sequence as transmitted using a carrier signal by at least one space vehicle (SV); and
at least one processing unit operatively coupled to said receiver, and operatively enabled to:
determine a current chip number associated with said spread-spectrum sequence;
determine a fraction of a chip associated with at least one carrier signal phase measurement sample; and
determine at least one SV transmit time based, at least in part on a local receiver time, said current chip number, and said fraction of said chip.

35. The apparatus as recited in claim 34, wherein said one processing unit is further operatively enabled to:
determine a carrier phase integer ambiguity associated with at least said at least one SV transmit time.

36. The apparatus as recited in claim 35, wherein said one processing unit is further operatively enabled to:
determine at least one cumulated carrier phase measurement based, at least in part, on said at least one SV transmit time and said carrier phase integer ambiguity.

37. The apparatus as recited in claim 36, wherein said one processing unit is further operatively enabled to:
determine a Double Difference (DD) Carrier Phase observable based, at least in part, on said at least one cumulated carrier phase measurement.

38. The apparatus as recited in claim 37, wherein said DD Carrier Phase observable is associated, at least in part, with at least said second device.

39. The apparatus as recited in claim 38, wherein said first device comprises a slave device and said second device comprises a master device.

40. The apparatus as recited in claim 39, wherein said one processing unit is further operatively enabled to:
establish said local receiver time based, at least in part, on synchronization information associated with said master device.

41. The apparatus as recited in claim 39, wherein said master device and said at least one SV are substantially synchronized to an SPS system time.

42. The apparatus as recited in claim 37, wherein said one processing unit is further operatively enabled to:
determine a transmit time ambiguity associated with said slave device based, at least in part, on at least one DD Carrier Phase observable; and
resolve a single unknown parameter vector based, at least in part, on a transmit time ambiguity associated with said slave device, and at least one DD integer ambiguity associated with at least said at least one SV.

43. The apparatus as recited in claim 37, wherein said one processing unit is further operatively enabled to:
determine a DD carrier phase linearization point based, at least in part, on said DD carrier phase observable; and
determine a relative position between at least said slave and master devices based, at least in part, on said DD carrier phase linearization point.
